(19) United States
(12) Patent Application Publication
(10) Pub. No.: US 2013/0175404 A1
(43) Pub. Date: Jul. 11, 2013

(54) AIRCRAFT WITH FIXED AND TILTING THRUSTERS

(71) Applicant: Mordechai Shefer, Haifa (IL)

(72) Inventor: Mordechai Shefer, Haifa (IL)

(21) Appl. No.: 13/717,752

(22) Filed: Dec. 18, 2012

(30) Foreign Application Priority Data
Dec. 18, 2011 (IL) 217070

(51) Int. Cl. B64C 39/00

(52) U.S. Cl. CPC B64C 39/00
USPC 244/7 A; 244/23 A; 244/17.21

(57) ABSTRACT

An aircraft including a fuselage with a yaw axis, a pitch axis and a roll axis, two attitude control thrusters, fixedly connected to the fuselage to provide thrust parallel to the yaw axis, two locomotion and hover thrusters. The aircraft further includes for the locomotion and hover thruster, a mechanism for tilting the locomotion and hover thruster about a tilt axis parallel to the pitch axis to select a direction, parallel to a first plane defined by the yaw and roll axes, in which the locomotion and hover thruster provides thrust.

### FIELD AND BACKGROUND OF THE INVENTION

The present invention relates to aircraft and, more particularly, to an aircraft that can take off and land vertically, hover, fly rapidly in any desired direction, and maneuver in tight spaces.

Various attempts have been made to achieve the combination of hovering and flying capabilities in one flying-and-hovering vehicle (FHV). The most familiar FHV is the helicopter. A typical helicopter is equipped with one large rotor, that rotates only in a horizontal plane, for locomotion, and one aft rotor, that rotates only in a vertical plane, for stabilization. The helicopter has two main disadvantages, which are,
i. The large rotor axis is fixed in the body frame, therefore its flying velocity typically is limited to about 150 Km/hr.
ii. Two rotors cannot possibly provide full controllability to a flying body, therefore the helicopter is a natively unstable platform. This in turn presents severe flying hazards as well as severe maneuverability limits.

Another quite familiar FHV, which was first attempted in the 1920s but that has recently been implemented more successfully, mainly for toys, is the quadrotor. A quadrotor has four identical body-fixed rotors for combined attitude control and locomotion. The disadvantage of the quadrotor is its severe speed and maneuverability limits which are induced by the fixed rotors attitudes in the body frame. This in turn forces the quadrotor to tilt its whole body in a certain direction whenever a motion in that direction is desired. Such a body-tilting is limited to small angles and it is also a time-consuming process that severely suppresses the vehicle's agility and response.

Several double tilted rotor (DTR) configurations have been implemented. A DTR has two tilting rotors, mounted together with their motors on the platform's wings. One example of a successfully implemented DTR is the Boeing V22 Osprey.

The common shortcoming of DTRs is in the exclusive use of aerodynamic surfaces only for attitude control. The efficiency of flight control surfaces depends on the vehicle air speed. Hence, the DTR configuration is natively unstable in hovering. This in turn induces flying hazards and poor maneuverability and response of the vehicle.

Boeing is working on a derivative of the V22 that has four identical tilted motors mounted on two pairs of wings which are arranged in tandem. The shortcomings of such a quad tilted rotor (QTR) configuration include:
i. An elastic structural instability mode which requires extra body and wings strength to overcome, hence extra weight and cost of the platform.
ii. Too many degrees of freedom in the control resources which in turn require an exceedingly complex and expensive locomotion and attitude control system.

Israel Aerospace Industries produces a DTR drone that also has a single non-tilting aft rotor to provide extra lift during takeoff, landing and hovering.

Another known FHV is the Skyhook JHL-40, a hybrid airship that uses non-tilting helicopter rotors for supplemental lift and for forward motion. Worldwide Aeros Corporation has proposed the Aeroscraft model ML866, a hybrid airship with downward-pointing turbofans and with aerodynamic surfaces for supplemental lift.

There is thus a widely recognized need for, and it would be highly advantageous to have, a FHV that is fully stable and controllable, fully acrobatic, safe to fly, capable of taking off and landing at any angle, highly maneuverability, fast, and simple and inexpensive to build and operate.

### SUMMARY OF THE INVENTION

According to the present invention there is provided an aircraft including: (a) a fuselage having a yaw axis, a pitch axis and a roll axis; (b) two attitude control thrusters, fixedly connected to the fuselage to provide thrust parallel to the yaw axis; (c) two locomotion and hover thrusters; and (d) for each locomotion and hover thruster, a mechanism for tilting the locomotion and hover thruster about a tilt axis parallel to the pitch axis to select a direction, parallel to a first plane defined by the yaw and roll axes, in which the each locomotion and hover thruster provides thrust.

According to the present invention there is provided an aircraft including: (a) a fuselage having a yaw axis, a pitch axis and a roll axis; (b) at least one attitude control thruster, fixedly connected to the fuselage to provide thrust parallel to the yaw axis; (c) two locomotion and hover thrusters; (d) for each locomotion and hover thruster, a mechanism for tilting the locomotion and hover thruster about a tilt axis parallel to the pitch axis to select a direction, parallel to a first plane defined by the yaw and roll axes, in which the each locomotion and hover thruster provides thrust; and (e) at least one aerodynamic foil fixedly connected to the fuselage; wherein none of the at least one aerodynamic foil includes a flight control surface.

A basic aircraft of a first embodiment of the present invention includes a fuselage, two attitude control thrusters and two locomotion and hover thrusters. The fuselage has three mutually perpendicular axes with respect to which the rotational maneuvers of the aircraft are defined: a yaw axis, a pitch axis and a roll axis. The attitude control thrusters are fixedly connected to the fuselage to provide thrust parallel to the yaw axis. The aircraft also includes a mechanism for, for each locomotion and hover thruster, tilting the locomotion and hover thruster about a tilt axis that is parallel to the pitch axis to select a direction, parallel to a first plane defined by the yaw and roll axes, in which the locomotion and hover thruster provides thrust.

In one class of embodiments, one or more of the thrusters includes a propeller. Spinning the propeller provides the thrust. The motor that spins the propeller could be mounted in the thruster itself (direct drive) or inside the fuselage (indirect drive via a mechanical linkage). In another class of embodiments, one or more of the thrusters includes a reaction motor to provide the thrust. A “reaction motor” is defined herein as a motor that produces from within itself a jet of a gas and expels the jet of gas in one direction to provide thrust in the opposite direction. Typical examples of such motors include jet engines and rocket engines, both of which burn a fuel to produce the jet of gas.

Preferably, the two attitude control thrusters and/or the two locomotion and hover thrusters are disposed symmetrically on opposite sides of the first plane.

Optionally, the mechanism for tilting the locomotion and hover thrusters tilts each locomotion and hover thruster independently.

Preferably, the aircraft also includes a wing that is substantially parallel to a second plane defined by the pitch and roll axes. Most preferably, the wing includes an elevon as an optional flight control surface. The term “elevon”, as used herein, includes in its scope a conventional aileron.

Preferably, the aircraft also includes a fin substantially parallel to a plane that includes the roll axis. For example, the fin could be a vertical fin that is substantially parallel the first plane, or a one of the fins, of a V-tail, that are substantially parallel to planes that include the roll axis and that bisect the right angles between the yaw axis and the pitch axis. Most preferably, the fin includes a rudder as an optional flight control surface. The term “rudder”, as used herein, includes in its scope both a conventional rudder of a vertical tail fin and a ruddervator of a fin of a V-tail.

A basic aircraft of a second embodiment of the present invention includes a fuselage, one or more attitude control thrusters and two locomotion and hover thrusters. The fuselage has three mutually perpendicular axes with respect to which the rotational maneuvers of the aircraft are defined: a yaw axis, a pitch axis and a roll axis. The attitude control thruster(s) is/are fixedly connected to the fuselage to provide thrust parallel to the yaw axis. The aircraft also includes a mechanism for, for each locomotion and hover thruster, tilting the locomotion and hover thruster about a tilt axis that is parallel to the pitch axis to select a direction, parallel to a first plane defined by the yaw and roll axes, in which the locomotion and hover thruster provides thrust.

The aircraft also includes one or more aerodynamic foils, such as wings that are substantially parallel to a second plane defined by the pitch and roll axes, and/or is such as a rudder that is substantially parallel to the roll axis and that preferably is parallel to the first plane, that are fixedly connected to the fuselage. An “aerodynamic foil” is defined herein as a relatively thin (in one of its three dimensions) solid object that protrudes from the fuselage into the airflow around the aircraft to provide lift and/or stability. This/these aerodynamic foil(s) lack movable flight control surfaces such as elevons or rudders.

In one class of embodiments, one or more of the thrusters includes a propeller. Spinning the propeller provides the thrust. The motor that spins the propeller could be mounted in the thruster itself (direct drive) or inside the fuselage (indirect drive via a mechanical linkage). In another class of embodiments, one or more of the thrusters includes a reaction motor to provide the thrust.

In principle, the aircraft could have just one attitude control thruster. Preferably, however, the aircraft includes two attitude control thrusters. Most preferably, the two attitude control thrusters are disposed symmetrically on opposite sides of the first plane. Similarly, it is preferred that the two locomotion and hover thrusters be disposed symmetrically on opposite sides of the first plane.

Optionally, the mechanism for tilting the locomotion and hover thrusters tilts each locomotion and hover thruster independently.

### BRIEF DESCRIPTION OF THE DRAWINGS

Various embodiments are herein described, by way of example only, with reference to the accompanying drawings, wherein:

FIG. 1 is a side view of an aircraft of the present invention;

FIG. 2 is a front view of an aircraft of the present invention;

FIG. 3 is a bottom view of an aircraft of the present invention.

### DESCRIPTION OF THE PREFERRED EMBODIMENTS

The principles and operation of a FHV according to the present invention may be better understood with reference to the drawings and the accompanying description.

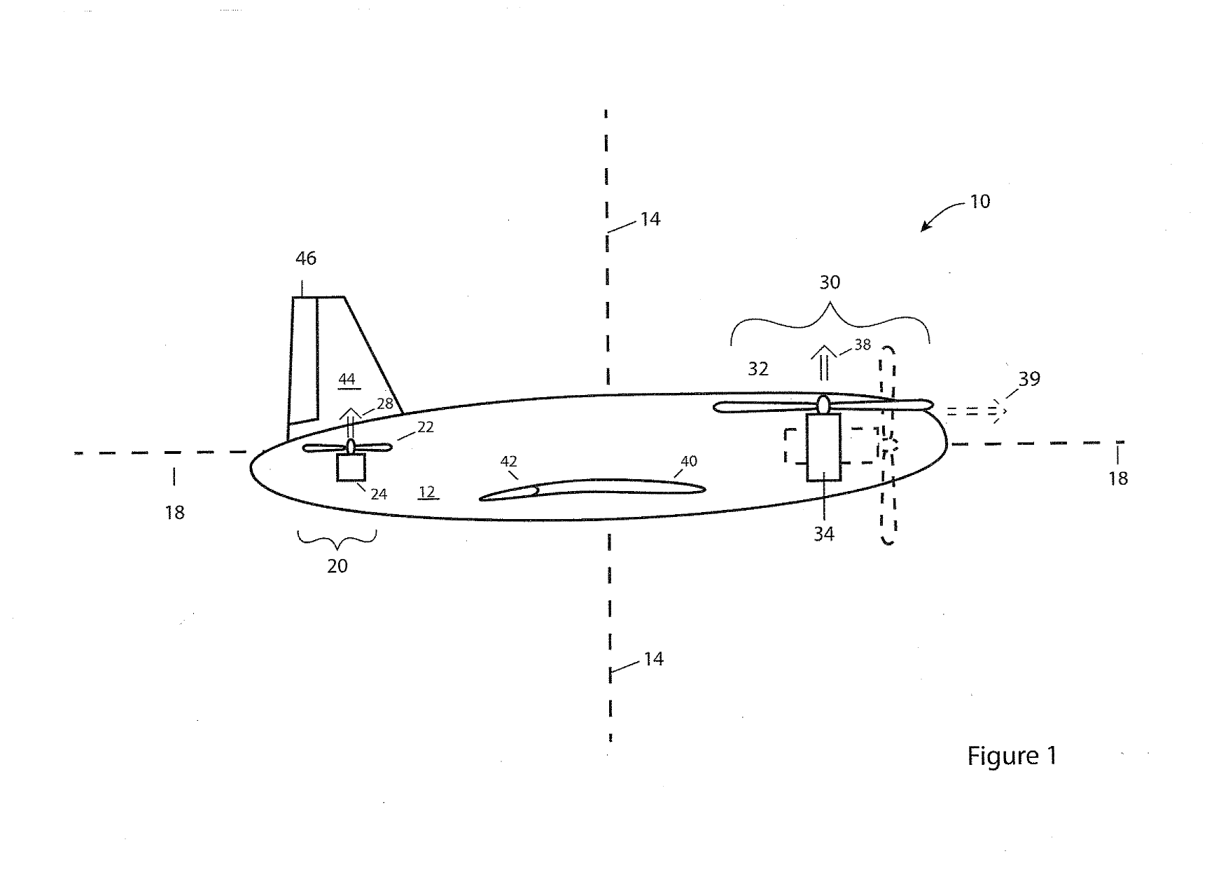

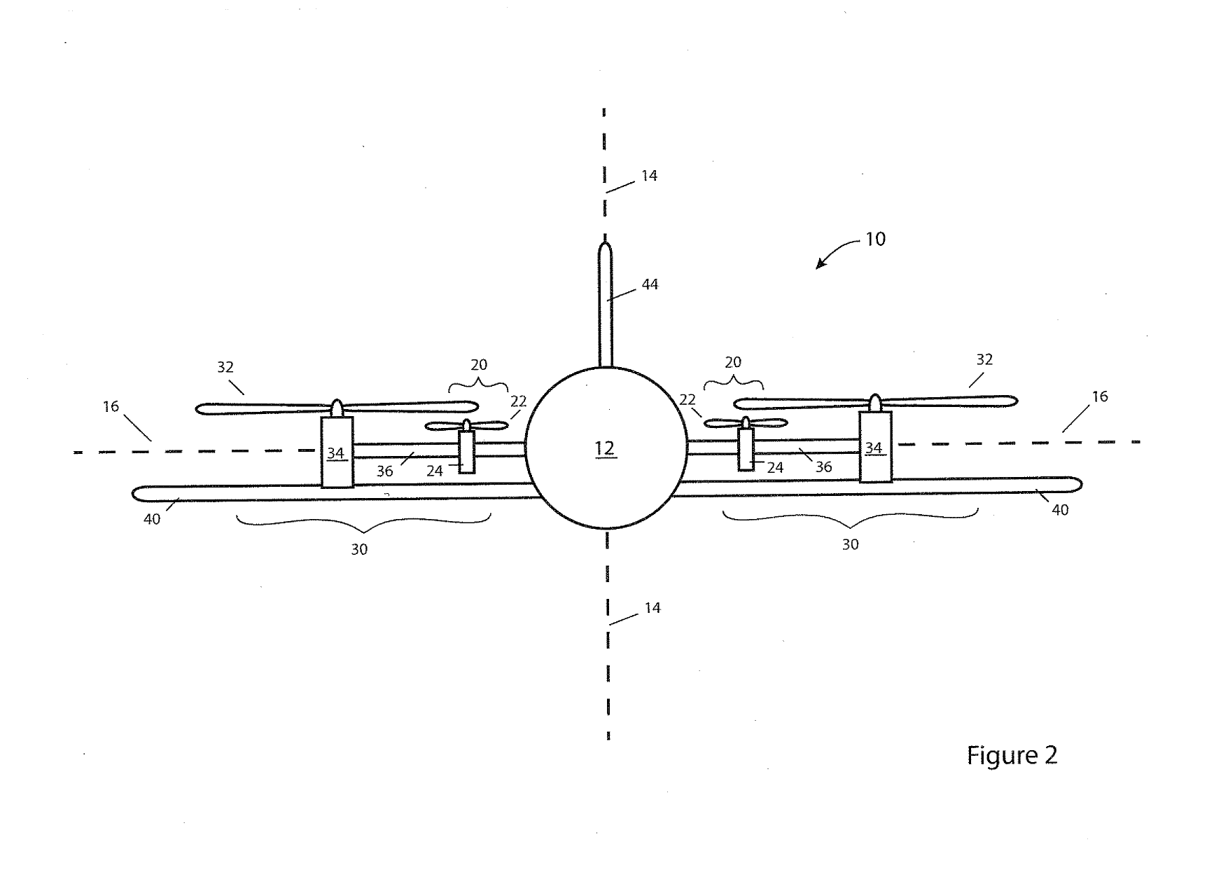

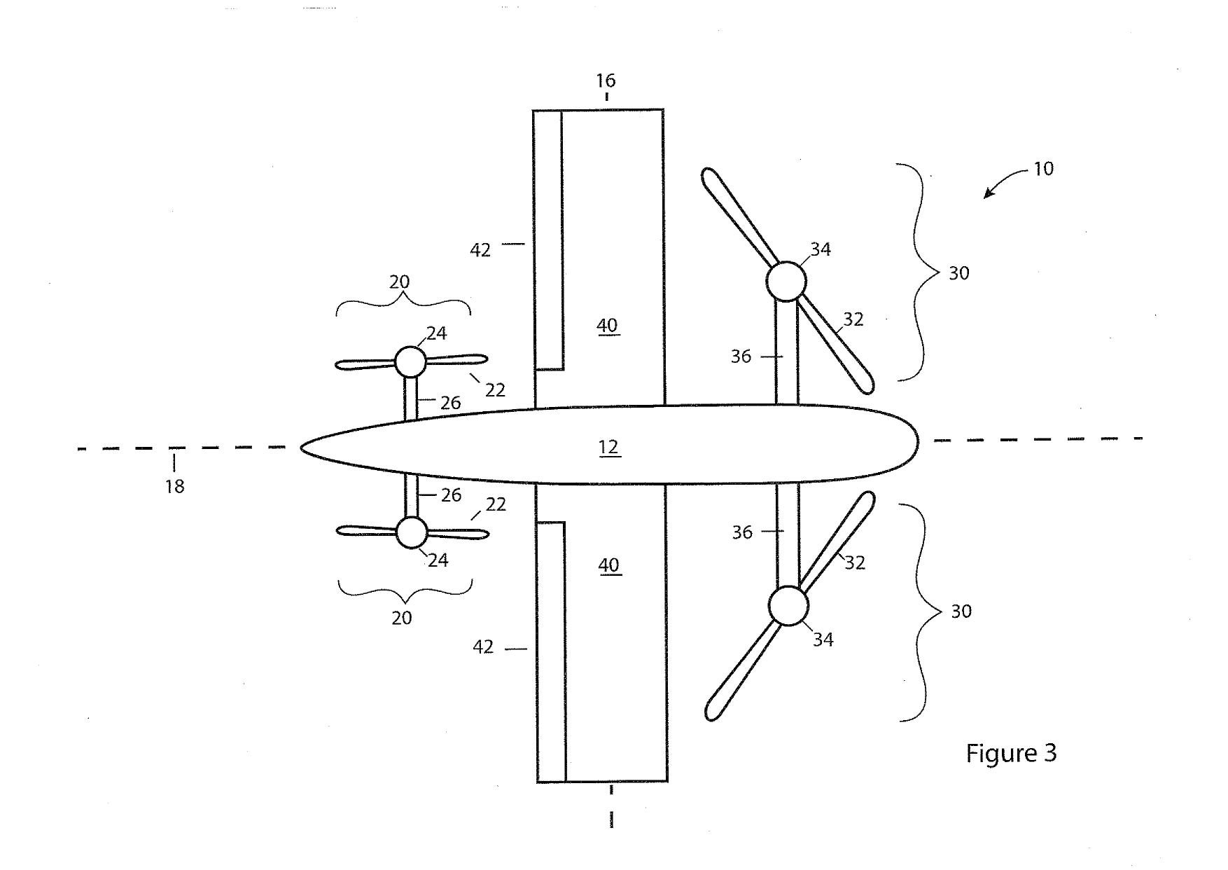

Referring now to the drawings, FIGS. 1-3 are, respectively, side, front and bottom views of an aircraft 10 of the present invention.

The core of aircraft 10 is a rigid fuselage 12. The turning maneuvers of aircraft 10 are defined in terms of three mutually perpendicular body-centered axes of fuselage 12: a yaw axis 14, a pitch axis 16 and a roll axis 18.

Extending laterally from both sides of fuselage 12, towards the front of fuselage 12, are two shafts 36 that support respective locomotion and hover thrusters 30. Each locomotion and hover thruster 30 includes a propeller 32 and a motor 34 for spinning propeller 32. Shafts 36 are coupled to motors (not shown) within fuselage 12 that turn shafts 36 to tilt locomotion and hover thrusters 30 parallel to the plane defined by axes 14 and 18, similar to how the wings of the V22 are turned to tilt the rotors of the V22. In other words, the tilt axes, about which locomotion and hover thrusters are rotated by shafts 36, are parallel to axis 16. The right-side locomotion and hover thruster 30 is shown in FIG. 1 in a vertical orientation, and in phantom in a horizontal orientation. In the vertical orientation, locomotion and hover thruster 30 produces upward thrust (parallel to axis 14), as indicated by arrow 38 in FIG. 1, by forcing air downwards. In the forward horizontal orientation, locomotion and hover thruster 30 produces forward thrust (parallel to axis 18), as indicated by phantom arrow 39 in FIG. 1, by forcing air rearwards. Shafts 36 also are able to tilt their locomotion and hover thrusters 30 at least partially towards the rear of fuselage 12. As will be seen below, the ability to tilt backwards facilitates yawing aircraft 10 about axis 14.

Extending laterally from both sides of fuselage 12, toward the rear of fuselage 12, are two struts 26 that support respective attitude control thrusters 20. Each attitude control thruster 20 includes a propeller 22 and a motor 24 for spinning propeller 32. Attitude control thrusters 20 are supported rigidly by struts 26 in the vertical orientation shown, so that attitude control thrusters 20 always force air downward and the direction of the thrust provided by attitude control thrusters always is upward (parallel to axis 14), as indicated by arrow 28 in FIG. 1.

Note that “upward” and “forward” thrust directions are defined relative to fuselage 12: both directions are parallel to the plane defined by axes 14 and 18.

Aircraft 10 hovers in place by using thrusters 20 and 30 to provide sufficient upward thrust, with all four thrusters 20 and 30 providing the same net upward thrust. To pitch aircraft 30 about axis 16, the amount of thrust provided by locomotion and hover thrusters 30 is set to be greater or less than the amount of thrust provided by attitude control thrusters 20. To roll aircraft 10 about axis 18, the amount of upward thrust provided by the thrusters 20 and 30 on one side of aircraft 10 is set to be greater or less than the amount of upward thrust provided by the thrusters 20 and 30 on the other side of aircraft 20.

Yawing aircraft 10 about axis 14 during hovering is accomplished by tilting locomotion and hover thrusters 30 at opposite angles from the vertical, accompanied by appropriate adjustments of the thrust provided by the locomotion and hover thrusters 30. For example, to yaw aircraft 10 to the left, the locomotion and hover thruster 30 on the right side of aircraft 10 is tilted forward towards the horizontal and the locomotion and hover thruster on the left side of aircraft 10 is tilted backwards by the same angle. It follows that locomotion and hover thrusters 30 must be capable of providing more total thrust than attitude control thrusters 20, so that the upward vectorial component of the thrust provided by locomotion and hover thrusters 30 remains equal to the (necessarily upward) thrust provided by attitude control thrusters 20 even though locomotion and hover thrusters 30 are tilted away from the vertical.

Aircraft 10 also has aerodynamic foils attached to fuselage 12, specifically, two wings 40 extending laterally from the sides of fuselage 12 approximately parallel to the plane defined by axes 16 and 18, and a tail fin 44 extending vertically from the rear of fuselage 12 in the plane defined by axes 14 and 18. Strictly speaking, wings 40 and fin 44 are optional because aircraft 10 can move and turn in any desired direction using just thrusters 20 and 30 as described above, but wings 40 and fin 44 assist thrusters 20 and 30 in these tasks. During forward flight, wings 40 provide lift that supplements the upward vectorial component of the thrust of locomotion and hover thrusters 30, which means that the excess thrust of locomotion and hover thrusters 30 over attitude control thrusters 20 does not have to be as great as it would have to be without wings 40. Wings 40 optionally include elevons 42, and fin 44 optionally includes a rudder 46, that are used as control surfaces during forward flight to supplement the pitch, yaw and roll capabilities of thrusters 20 and 30. Elevons 42 and rudder 44 truly are optional because aircraft 10 is perfectly capable of maneuvering even if wings 40 and fin 44 lack flight control surfaces.

Forward motion of aircraft 10 is accomplished by tilting locomotion and hover thrusters 30 together forwards towards the horizontal. If wings 40 provide sufficient supplemental lift during horizontal flight that locomotion and hover thrusters 30 are not needed for vertical thrust, aircraft 10 yaws by providing more horizontal thrust from one locomotion and hover thruster 30 than from the other locomotion and hover thruster 30.

In one class of variants of the design illustrated in FIGS. 1-3, instead of using motor-driven external propellers to create thrust, thrusters 20 and/or 30 use reaction motors such as turbojets or rockets. In another class of variants of the design illustrated in FIGS. 1-3, the motors that drive some or all of the propellers are housed within fuselage 12 and drive the propellers via mechanical linkages.

Another, less preferred variant of aircraft 10 has only one attitude control thruster 20, at the tail of fuselage 12.

In another class of variants of the design illustrated in FIGS. 1-3, attitude control thrusters 20 are disposed towards the front of fuselage 12 and locomotion and hover thrusters 30 are disposed towards the rear of fuselage 12. In this class of variants, forward motion is obtained by tilting locomotion and hover thrusters horizontally backwards, in a pusher configuration.

Other variants of the design illustrated in FIGS. 1-3 have two pairs of wings 40, for example in a tandem configuration (one pair behind the other) or in a biplane configuration (one pair above the other).

Aircraft 10 can take off and land at any desired angle between zero degrees (horizontal, from/to a runway) and ninety degrees (vertical). Once airborne, aircraft 10 can change its flight path angle rapidly between horizontal and vertical, and even between forward horizontal and backward horizontal if shafts 36 are configured to rotate locomotion and hover thrusters 30 a full 180° from facing forward to facing rearward. In horizontal flight, aircraft 10 can reach and maintain an airspeed of several hundred km/hr. Aircraft 10 has full controllability and full aerobatic capability, including very small turn radii about all three axes 14, 16 and 18. These properties make aircraft 10 independent of runway availability and independent of external launching devices.

One very useful embodiment of aircraft 10 is as an unmanned aerial vehicle (UAV), or drone. In this configuration, fuselage 12 contains within itself an electrical power source such as batteries or fuel cells, electronic processors, a communications and command system and a day/night video camera. The high omni-directional maneuverability of aircraft 10 makes the UAV embodiment of aircraft 10 ideally suited to visual intelligence acquisition in crowded urban areas that have very narrow alleys, as well as in deep canyons and in caves.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. An aircraft comprising:
(a) a fuselage having a yaw axis, a pitch axis and a roll axis;
(b) two attitude control thrusters, fixedly connected to said fuselage to provide thrust parallel to said yaw axis;
(c) two locomotion and hover thrusters; and
(d) for each said locomotion and hover thruster, a mechanism for tilting said locomotion and hover thruster about a tilt axis parallel to said pitch axis to select a direction, parallel to a first plane defined by said yaw and roll axes, in which said each locomotion and hover thruster provides thrust.

2. The aircraft of claim 1, wherein at least one of said attitude control thrusters includes a propeller.

3. The aircraft of claim 1, wherein at least one of said attitude control thrusters includes a reaction motor.

4. The aircraft of claim 1, wherein at least one of said locomotion and hover thrusters includes a propeller.

5. The aircraft of claim 1, wherein at least one of said locomotion and hover thrusters includes a reaction motor.

6. The aircraft of claim 1, wherein two of said attitude control thrusters are disposed symmetrically on opposite sides of said first plane.

7. The aircraft of claim 1, wherein two of said locomotion and hover thrusters are disposed symmetrically on opposite sides of said first plane.

8. The aircraft of claim 1, wherein said mechanism tilts each said locomotion and hover thruster independently.

9. The aircraft of claim 1, further comprising a wing substantially parallel to a second plane defined by said pitch and roll axes.

10. The aircraft of claim 9, wherein said wing includes an elevon.

11. The aircraft of claim 1, further comprising a fin substantially parallel to a plane that includes said roll axis.

12. The aircraft of claim 11, wherein said fin is substantially parallel to said first plane.

13. The aircraft of claim 11, wherein said fin includes a rudder.

14. An aircraft comprising:
(a) a fuselage having a yaw axis, a pitch axis and a roll axis;
(b) at least one attitude control thruster, fixedly connected to said fuselage to provide thrust parallel to said yaw axis;
(c) two locomotion and hover thrusters;
(d) for each said locomotion and hover thruster, a mechanism for tilting said locomotion and hover thruster about a tilt axis parallel to said pitch axis to select a direction, parallel to a first plane defined by said yaw and roll axes, in which said each locomotion and hover thruster provides thrust; and
(e) at least one aerodynamic foil fixedly connected to said fuselage;
wherein none of said at least one aerodynamic foil includes a flight control surface.

15. The aircraft of claim 14, wherein one of said at least one attitude control thruster includes a propeller.

16. The aircraft of claim 14, wherein one of said at least one attitude control thruster includes a reaction motor.

17. The aircraft of claim 14, wherein one of said locomotion and hover thrusters includes a propeller.

18. The aircraft of claim 14, wherein one of said locomotion and hover thrusters includes a reaction motor.

19. The aircraft of claim 14, comprising two of said attitude control thrusters.

20. The aircraft of claim 19, wherein said two attitude control thrusters are disposed symmetrically on opposite sides of said first plane.

21. The aircraft of claim 14, wherein two of said locomotion and hover thrusters are disposed symmetrically on opposite sides of said first plane.

22. The aircraft of claim 14, wherein said mechanism tilts each said locomotion and hover thruster independently.

23. The aircraft of claim 14, wherein one of said at least one aerodynamic foil is a wing substantially parallel to a second plane defined by said pitch and roll axes.

24. The aircraft of claim 14, wherein one of said at least one aerodynamic foil is a fin substantially parallel to a plane that includes said roll axis.

25. The aircraft of claim 24, wherein said fin is substantially parallel to said first plane.
